(19) United States
(12) Patent Application Publication
(10) Pub. No.: US 2013/0169168 A1
(43) Pub. Date: Jul. 4, 2013

(54) METHOD FOR CONTROLLING GROUPED DEVICES

(71) Applicants: Chun-Chieh Lin, New Taipei City (TW); Ming-Han Tsai, New Taipei City (TW); Chih-Hao Chen, New Taipei City (TW)

(72) Inventors: Chun-Chieh Lin, New Taipei City (TW); Ming-Han Tsai, New Taipei City (TW); Chih-Hao Chen, New Taipei City (TW)

(21) Appl. No.: 13/557,227

(22) Filed: Jul. 25, 2012

(30) Foreign Application Priority Data
Dec. 29, 2011 (TW) 100149522

(51) Int. Cl. G05B 19/02; H05B 37/02

(52) U.S. Cl. 315/154; 340/4.32

(57) ABSTRACT

A method for controlling grouped devices is disclosed. The method includes receiving a group setting from a group switch on each of the electronic devices, the electronic devices being divided into a plurality of groups according to the group setting of the group switch; a control device emitting a wireless signal comprising group data and operation data to the electronic devices; each of the electronic devices determining whether the group data matches the group setting of the group switch; and if the group data matches the group setting of the group switch, the electronic devices with the group setting matching the group data performing an operation according to the operation data.

### BACKGROUND OF THE INVENTION

1. Field of the Invention

The present invention relates to a method for controlling grouped devices, and more particularly, to a method for controlling grouped devices according to a group switch.

2. Description of the Prior Art

As related technology keeps improving, functions of an electronic device become more and more powerful. The current electronic device is capable of wirelessly surfing Internet, transmitting data, and even remote-controlling electrical appliance, etc. For the general home use, a remote control of electrical appliance is a widely used technology. The remote control can remotely control the electrical appliance by emitting infrared signals or other types of wireless signals. However, each electrical appliance has a corresponding remote-control frequency band, such that a user needs to use different remote control emitting different remote control signals corresponding to the predefined frequency bands in order to control different electrical appliances. In addition, when the user uses a remote control corresponding to a plurality of identical electrical appliances, the user is not able to solely control a particular electrical appliance due to the electrical appliances having the same remote-control frequency band. Therefore, in the prior art, the user can not utilize the remote control to respectively control different groups of electrical appliances with a same predefined frequency band.

### SUMMARY OF THE INVENTION

The present invention provides a method for controlling grouped devices. The method comprises receiving a group setting from a group switch on each of the electronic devices, the electronic devices being divided into a plurality of groups according to the group setting of the group switch; a control device emitting a wireless signal comprising group data and operation data to the electronic devices; each of the electronic devices determining whether the group data matches the group setting of the group switch; and if the group data matches the group setting of the group switch, the electronic devices with the group setting matching the group data performing an operation according to the operation data.

The present invention further provides a grouping control system. The grouping control system comprises a master control device and a plurality of slave devices. The master control device comprises a control circuit for generating group data and operation data, and a first wireless unit for wirelessly transmitting the group data and the operation data. Each of the plurality of slave devices comprises a second wireless unit, a group switch, and a controller. The second wireless unit is for receiving the group data and the operation data. The group switch is switchable to one of a plurality of group settings. The controller is electrically connected to the second wireless unit and the group switch, and the controller controls the slave device performing an operation according to the operation data if the group data matches the group setting of the group switch.

The present invention further provides an electronic device. The electronic device comprises a wireless unit, a group switch, and a controller. The wireless unit is for receiving a wireless signal including group data and operation data. The group switch is switchable to one of a plurality of group settings. The controller is electrically connected to the wireless unit and the group switch, and the controller is for controlling the electronic device performing an operation according to the operation data if the group data matches the group setting of the group switch.

In contrast to the prior art, the present invention provides a method for controlling grouped devices. The present invention can easily configure the slave devices into different groups by setting the group switch, and the present invention can respectively control the different group of slave devices at a same predetermined frequency band. The control method and the control system of the present invention can control the grouped devices easily and efficiently.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a master control device of a grouping control system according to the present invention.

FIG. 2 is a diagram showing a slave device of the grouping control system according to the present invention.

FIG. 3 is a diagram showing the grouping control system according to the present invention during operation.

FIG. 4 is a diagram showing another embodiment of the grouping control system according to the present invention during operation.

FIG. 5 is a flowchart showing a method for controlling the grouped devices according to the present invention.

### DETAILED DESCRIPTION

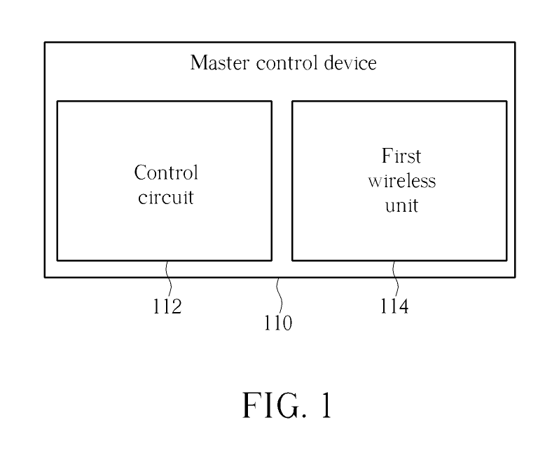

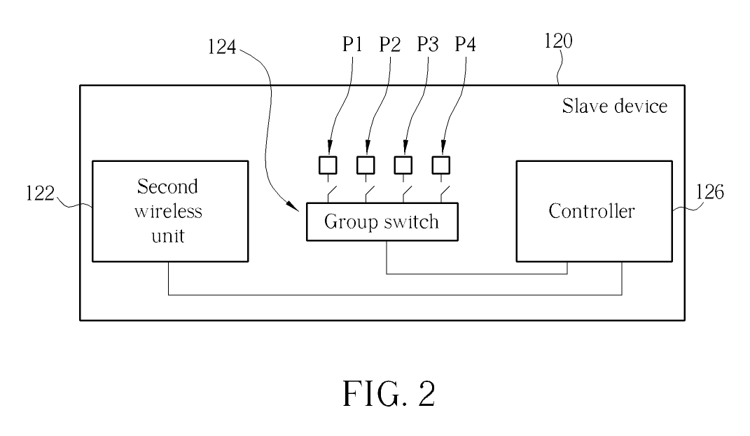

Please refer to FIG. 1 and FIG. 2. FIG. 1 is a diagram showing a master control device of a grouping control system according to the present invention. FIG. 2 is a diagram showing a slave device of the grouping control system according to the present invention. The master control device 110 of the present invention comprises a control circuit 112, and a first wireless unit 114. The control circuit 112 generates group data and operation data according to commands transmitted from other electronic devices. The first wireless unit 114 wirelessly transmits the group data and the operation data generated by the control circuit 112. The slave device 120 of the present invention comprises a second wireless unit 122, a group switch 124, and a controller 126. The second wireless unit 122 receives the group data and the operation data from the first wireless unit 114. The group switch 124 comprises a plurality of pins P1, P2, P3, P4, and each pin corresponds to a predetermined group setting. A user can define any of the slave devices 120 as belonging to one group by setting the pin corresponding to the group to be conducted. That is, the user can control the group setting of the slave device 120 via the group switch 124. The controller 126 is electrically connected to the second wireless unit 122 and the group switch 124. The controller 126 controls the slave device 120 according to the conducted pin of the group switch 124, the received group data, and the received operation data. The group switch 124 can be a turntable, a wheel, a button, a drawstring, or other type of switch installed on the slave device. For example, in an embodiment of the present invention, the slave device 120 is a light bulb, and the group switch 124 is arranged on the light bulb. The user can set the group setting of the light bulb by setting the group switch 124 and then installs the light bulb onto a light fixture, or the user can directly adjust the group switch 124 of the light bulb at the light fixture for adjusting the group setting of the light bulb.

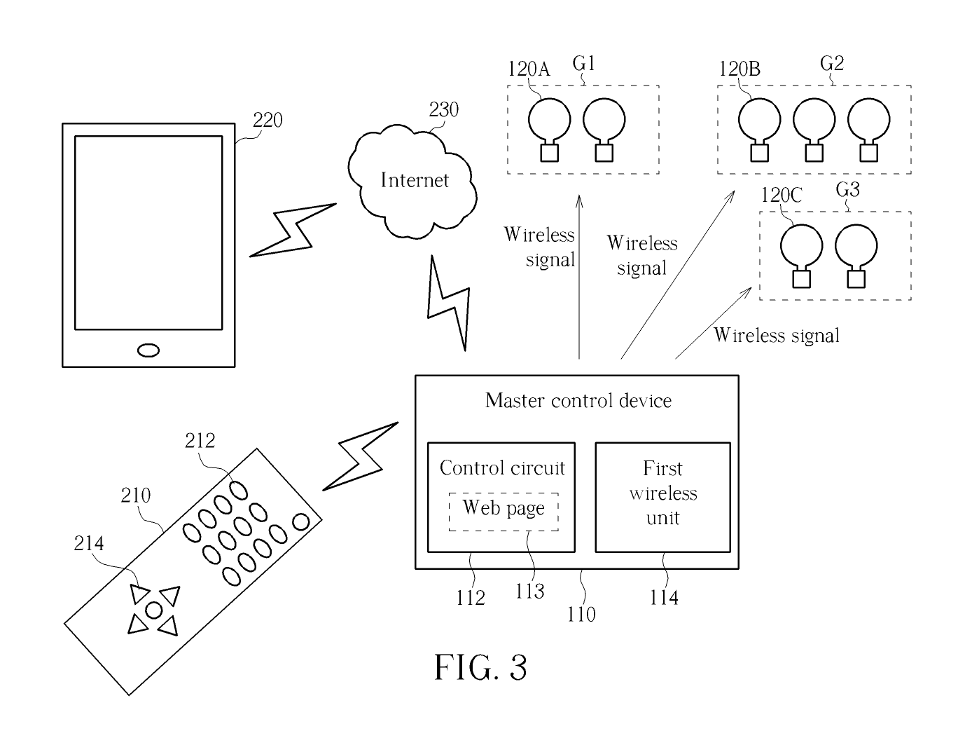

According to the above arrangement, the grouping control system of the present invention can respectively control the slave devices of different groups according to the settings of the conducted pins of the group switches. Please refer to FIG. 3, and refer to FIG. 1 and FIG. 2 as well. FIG. 3 is a diagram showing the grouping control system according to the present invention during operation. For example, the grouping control system of the present invention can be an illumination system. Each of the slave devices, such as 120A, 120B, 120C, is an illumination device. The pin of the group switch 124 in the illumination device 120A corresponding to a first group G1 is the first pin P1, the pin of the group switch 124 in the illumination device 120B corresponding to a second group G2 is the second pin P2, and the pin of the group switch 124 in the illumination device 120C corresponding to a third group G3 is the third pin P3. When the user try to reduce brightness of the illumination devices 120B belonging to the second group G2, the user can utilize a remote control 210 or a smart phone 220 for transmitting commands to the control circuit 112 of the master control device 110. The control circuit 112 then generates group data and operation data according to the received commands, wherein the illumination device 120B of the second group G2 is one of the controlled targets indicated by the group data, and the operation to be performed indicated by the operation data is reducing brightness. Thereafter, the first wireless unit 114 will emit a wireless signal in a predetermined frequency band wherein the wireless signal comprises the group data and the operation data generated by the control circuit 112. Therefore, only the illumination devices in the same group corresponding to the group data included in the wireless signal will react according to the operation data. The illumination devices of other groups will not react according to the wireless signal. When all the illumination devices, including 120A, 120B, 120C, of the groups G1, G2, G3 receive the wireless signal, the controller 126 of the illumination devices will determine whether the received group data corresponds to the conducted pin of the group switch 124 in the illumination devices. When the group data matches the conducted pin of the group switch 124, the controller 126 of the illumination device performs a corresponding operation according to the operation data. For example, the controller 126 of the illumination device 120B in the second group G2 will reduce the brightness. When the group data does not match the conducted pin of the group switch 124, the controller 126 of the illumination device will not perform the operation of the operation data. For example, the controllers 126 of the illumination device 120A in the first group G1 and the controllers 126 of the illumination device 120C in the third group G3 will remain in original illumination status.

In addition, there are different ways for transmitting the commands to the control circuit 112 of the master control device 110. For example, a web page 113 can be embedded within the control circuit 112 of the master control device 110, wherein the web page 113 is provided with group options and operation options. The user can utilize the smart phone 220 or other devices to browse the web page 113 via Internet 230, and then select remote controlled group and operation to be performed by the selected group on the web page 113. Then the control circuit 112 will generate the group data and the operation data according to the user's command on the web page 113. Or the user can press number keys 212 on the remote control 210 to select the remote controlled group, and press the number keys 212 or function keys 214 on the remote control 210 to select the operation to be performed. After the control circuit 112 receives wireless control signals transmitted from the remote control 210, the control circuit 112 generates the group data and the operation data according to the wireless control signals.

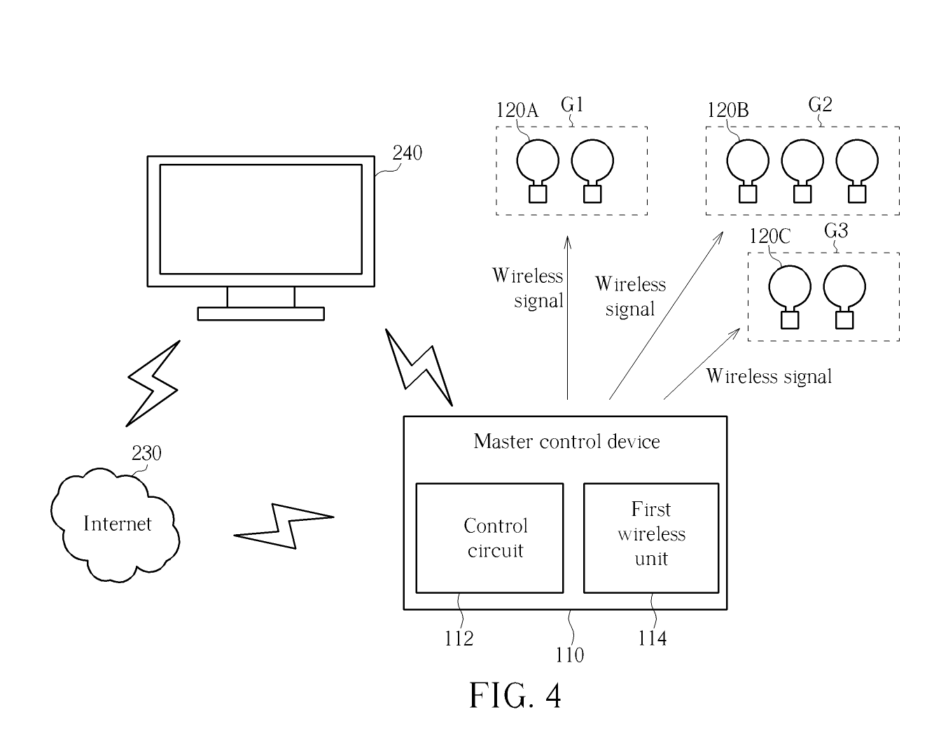

Please refer to FIG. 4, and refer to FIG. 1 and FIG. 2 as well. FIG. 4 is a diagram showing another embodiment of the grouping control system according to the present invention during operation. As shown in FIG. 4, the control circuit 112 of the master control device 110 can also communicate with a display device 240 via Internet 230 or the first wireless unit 114. The control circuit 112 can generate the group data and the operation data according to the settings for different scenarios of the display device 240 when displaying video and images. For example, when the display device 240 is set to display video in a movie mode, the control circuit 112 can correspondingly generate the group data and the operation data for dimming the illumination device 120A, or changing color of light, of the first group G1 which is near the display device 240. The illumination device 120B of the second group G2 and the illumination device 120C of the third group G3 located in other areas will remain in the original illumination status, such that the activities of the users in other areas will not be affected.

In the above embodiment, the group data comprises indicator of a group. However, in other embodiments, the group data can also comprise indicators of a plurality of groups for simultaneously remote controlling the plurality of groups. In addition, the slave devices 120 are not limited to the illumination devices. The slave devices 120 can be other types of electronic devices, and the slave devices belonging to a group are not required to be the same devices. Also, the slave devices of different groups can be different types of electronic devices, as long as the electronic device comprises a group switch for being controlled by the wireless signal having the group data. The master control device 110 can further provide different types of settings for controlling a combination of different types of electronic devices, so the user can select one type of the settings for simultaneously controlling the different types of electronic devices. Therefore, the user can utilize the same master control device to control the different types of electronic devices in the same predetermined frequency band, and the different types of electronic devices can be interactive via the links to master control device. For example, the display device 240 and the illumination devices 120A, 120B, 120C can be simultaneously controlled by the master control device 110. When the user utilizes the master control device 110 to set the scenario setting in a movie mode, the master control device 110 can correspondingly generate the group data and the operation data for setting the display device 240 to display video in the movie mode, and simultaneously generates the group data and the operation data for controlling the illumination device 120A belonging to the first group G1 near the display device 240, so the illumination mode of the illumination device 120A can be adjusted according to the display mode of the display device 240. The above example is one of the embodiments of the present invention. The combination of the master control device 1110 and the slave device 120 of the present invention is not limited to the above embodiments. The slave device 120 can be other electronic devices, such as a stereo, a computer, a handheld device, etc., and the group settings and function settings of these slave devices can still be set through the master control device 110.

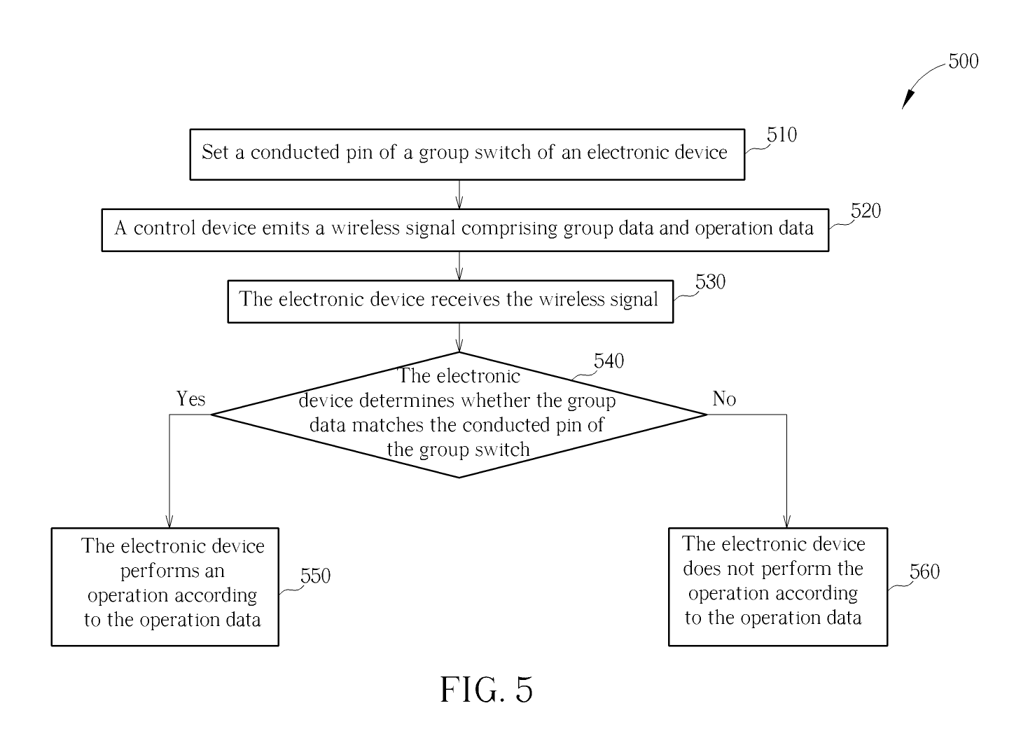

Please refer to FIG. 5. FIG. 5 is a flowchart 500 showing a method for controlling the grouped devices of the present invention. The flowchart of the method for controlling the grouped devices of the present invention comprises the following steps:

Step 510: Set a pin of a group switch in an electronic device to be conducted, wherein the conducted pin is corresponding to the group that the electronic device belongs to;

Step 520: A control device emits a wireless signal comprising group data and operation data;

Step 530: The electronic device receives the wireless signal;

Step 540: The electronic device determines whether the group data matches the conducted pin of the group switch;

Step 550: When the group data matches the conducted pin of the group switch, the electronic device performs an operation according to the operation data; and

Step 560: When the group data does not match the conducted pin of the group switch, the electronic device does not perform the operation according to the operation data.

In contrast to the prior art, the present invention provides a method for controlling grouped devices. The present invention can easily configure the slave devices into different groups by setting the group switch, and the present invention can respectively control the different group of slave devices at a same predetermined frequency band. The control method and the control system of the present invention can control the grouped devices easily and efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a plurality of electronic devices, comprising:
receiving a group setting from a group switch on each of the electronic devices, the electronic devices being divided into a plurality of groups according to the group setting of the group switch;
a control device emitting a wireless signal comprising group data and operation data to the electronic devices;
each of the electronic devices determining whether the group data matches the group setting of the group switch; and
if the group data matches the group setting of the group switch, the electronic devices with the group setting matching the group data performing an operation according to the operation data.

2. The method of claim 1, wherein a web page is embedded within the control device and the web page provides a control function to control the plurality of electronic devices, the method further comprising:
a network device accessing the web page and send a command for controlling at least one group of the electronic devices by utilizing the control function of the web page; and
the control device generating the group data and the operation data according to the command.

3. The method of claim 1 further comprising:
a wireless device emitting a wireless control signal to the control device; and
the control device generating the group data and the operation data according to the wireless control signal.

4. The method of claim 1 further comprising the control device generating the group data and the operation data according to a scenario setting of a second electronic device.

5. The method of claim 1, wherein the operation data is lighting control data, and the electronic devices with the group setting matching the group data performing the operation according to the operation data is the electronic devices controlling the illumination of light emitted from the electronic devices according to the lighting control data.

6. The method of claim 1, wherein the wireless signal is emitted at a predetermined frequency band.

7. The method of claim 1 further comprising:
setting a first electronic device to a scenario setting; and
the control device generating the group data and the operation data according to the scenario setting of the first electronic device.

8. A grouping control system, comprising:
a master control device, comprising:
a control circuit for generating group data and operation data; and
a first wireless unit for wirelessly transmitting the group data and the operation data; and
a plurality of slave devices, each slave device comprising:
a second wireless unit for receiving the group data and the operation data;
a group switch being switchable to one of a plurality of group settings; and
a controller electrically connected to the second wireless unit and the group switch, the controller controlling the slave device performing an operation according to the operation data if the group data matches the group setting of the group switch.

9. The control system of claim 8, wherein the controller of the slave devices do not perform the operation according to the operation data if the group data does not match the group setting of the group switch.

10. The control system of claim 8, wherein a web page is provided by the master control device, the web page provides a control function of the slave devices, and the control circuit generates the group data and the operation data according to a received command from the web page.

11. The control system of claim 8, wherein the plurality of slave devices are illumination devices and the operation data is lighting control data.

12. The control system of claim 8 further comprising:
a first electronic device having a plurality of scenario settings;
wherein the first electronic device transmits a control signal to the master control device when the first electronic device is set to one of the scenario settings, and the master control device generates the group data and the operation data to the slave devices according to the control signal.

13. The control system of claim 8, wherein the master control device have a plurality of scenario settings, the master control device generates the group data and the operation data to the slave devices when the master control device is set to one of the scenario settings.

14. The control system of claim 8, wherein the group data and the operation data is transmitted at a predetermined frequency band.

15. An electronic device, comprising:
a wireless unit receiving a wireless signal including group data and operation data;
a group switch being switchable to one of a plurality of group settings; and
a controller electrically connected to the wireless unit and the group switch, the controller controlling the electronic device performing an operation according to the operation data if the group data matches the group setting of the group switch.

16. The electronic device of claim 15, further comprising:
a light source being controlled by the controller;
wherein the operation data is lighting control data and the controller controls the illumination of the light source.

17. The electronic device of claim 15, wherein the wireless signal is transmitted at a predetermined frequency band.

18. The electronic device of claim 15, wherein the group switch has a plurality of pins connected to a switch component, each of the pins is corresponding to one of the group settings, the switch component is switchable to conduct one of the pins to the controller.

19. The electronic device of claim 15, wherein the wireless unit receives the wireless signal from a master control device, and the master control device provides a web page with control function of controlling the electronic device.

20. The electronic device of claim 15, wherein the wireless unit receives the wireless signal from a master control device, the master control device provides a plurality of scenario settings to be selected, and the master control device generates the group data and the operation data according to a selected scenario setting.
